(19) United States
(12) Patent Application Publication
(10) Pub. No.: US 2008/0047370 A1
(43) Pub. Date: Feb. 28, 2008

(54) Sampling apparatus for constituents in natural gas lines

(76) Inventor: James H. Vickery JR., New Orleans, LA (US)

Correspondence Address: MORGAN, LEWIS & BOCKIUS, LLP, ONE MARKET SPEAR STREET TOWER, SAN FRANCISCO, CA, 94105, US

(21) Appl. No.: 11/835,288

(22) Filed: Aug. 7, 2007

Related U.S. Application Data
(60) Provisional application No. 60/836,283, filed on Aug. 7, 2006.

(51) Int. Cl. G01N 1/22

(52) U.S. Cl. 73/863.21

(57) ABSTRACT

A sampling apparatus for mercury in natural gas lines includes a source line fluidly connected to a natural gas line and configured for delivering a sample gas flow, a directional valve fluidly connected with the source line and configured for selecting a flow direction of the sample gas flow, a bypass line connected to the directional valve and configured for drawing off the sample gas, and a sample line assembly fluidly connected to the directional valve. The sample line assembly includes a plurality of sample trains, and each of the sample trains includes (i) a shut-off valve at an upper end thereof configured to control the sample flow therethrough, (ii) a measuring device at a lower end thereof configured for measuring flow therethrough, and (iii) a sample trap assembly intermediate the shut-off valve and the measuring device configured for collecting constituents in the sample gas flow. A method of using the sampling apparatus for mercury in natural gas lines is also disclosed.

### CROSS-REFERENCE TO RELATED APPLICATION

This application is a non-provisional of, and claims the benefit of the filing date of, U.S. Provisional Application No. 60/836,283 filed on Aug. 7, 2006.

### TECHNICAL FIELD OF THE INVENTION

This invention relates, in general, to sampling apparatus for sampling constituents in natural gas lines and more particularly to mercury sampling apparatus and methods for their use.

### BACKGROUND OF THE INVENTION

Natural gas serves as a primary ingredient in various host products for everyday applications. Natural gas can be processed into fabric, plastics, and fertilizer, however, it is best known for electricity generation and residential cooking and heating.

Natural gas is a fossil fuel primarily composed of methane and other hydrocarbons. Natural gas has been found and retrieved from several locations around the world. Recently, the demand for natural gas has boomed. Additionally, geopolitical issues and natural disasters have further strained the supply of raw and processed natural gas. In response, there has been added incentive to explore in areas that were previously uneconomical. This includes digging deeper into the earth for reserves.

At the same time, increased regulatory oversight and other issues have focused the industry on the quality and composition of the natural gas obtained and delivered. In particular, in the last few decades several high-profile accidents have led researchers to study the composition of raw natural gas as it relates to equipment failure and environmental problems. Historically, it had been thought that only trace contaminants existed in natural gas and thus had little or no affect. However, recent research suggests that substantial contaminants may in fact exist in natural gas and cause a host of problems.

Several contaminants or constituents commonly found in natural gas have proven to be of particular concern for several reasons. Such contaminants include mercury, carbon dioxide, arsenic, organosulfur, hydrogen sulfide, and others. Natural gas with high levels of contaminants such as H₂S is commonly referred to as sour gas or acid gas. These contaminants pose health, toxicological, and environmental risks. For example, contaminants found in natural gas lines pose health risks both to those in the industry and end-users or consumers. Additionally, the contaminants can be harmful to the environment if released and have thus drawn increased regulatory scrutiny. Most importantly, constituents such as mercury can cause expensive damage to gas processing equipment. Several constituents aggressively attack and corrode gas processing equipment. Some contaminants can even destroy catalysts in the processing and refining processes. Other contaminants negatively affect the quality of the gas for processing.

Such constituents may be produced along with the production of natural gas. The source of these constituents can be the geological formation from which they are produced. As depth of drilling has increased, the amount of constituents in the gas recovered has likewise increased. Many constituents may also be introduced anthropologically during delivery. Mercury and the like are naturally distributed throughout the environment including in bodies of water, rain, air, and soil. Thus, as economics have driven the expansion of delivery gas lines, there has been increased concern over the amount of constituents accumulated in gas streams.

Mercury poses several unique problems versus other contaminants commonly found in natural gas. Mercury is well known to be highly toxic to humans. Exposure to mercury can cause severe health problems even in trace amounts.

Additionally, mercury has proven to be more aggressive in attacking gas processing equipment than many other contaminants. Recent research has proven mercury to have especially harmful affects in natural gas processing systems. Mercury promotes the corrosion and galvanization of gas processing equipment, which can lead to the costly destruction and failure of equipment. Aluminum is a popular material for gas processing equipment because of its physical properties such as its high strength-to-weight ratio. However, aluminum is also highly susceptible to attack from mercury. Aluminum heat exchangers are thus a particular concern and frequent source of system failures.

Mercury has unique chemical properties that make it especially problematic in comparison to other contaminants. Of particular concern are the thermal properties of mercury. In fact, mercury is one of only two elements found in liquid form at ambient and tends to be in a different state than the natural gas and other elements. It also is has a high density and is reactive with many elements found in natural gas. As cryogenic processing has increased, sampling for mercury has become increasingly important because of the tendency of mercury to accumulate as a liquid at the bottom of natural gas processing equipment. Mercury is especially problematic with respect to equipment such as heat exchangers, compressor labyrinth seals, and turboexpander wheels.

Whereas it was once thought that mercury only existed in negligible amounts in natural gas, research has shown that it can be found in natural gas in substantial levels. Mercury can be found in various forms such as the free or metallic form, in the organic state (such as dimethyl-mercury), and in the ionic or salt state. It can also bond with other contaminants to form mercuric sulfide and the like.

For all the reasons above, sampling of natural gas for contaminants, especially mercury, has become a necessary practice. In response, gas samplers have been designed to detect and measure the level of different target constituents in natural gas. With respect to mercury and other contaminants, such samplers are designed to detect even trace amounts of constituent matter.

High levels of mercury and other constituents may be measured on-site using known natural gas analyzers. Known analyzers utilize concepts such as vapor atomic fluorescence, mass spectrometry, and direct adsorption by bubbling gas through an acid solution.

In response to the need for detecting trace amounts of constituents in natural gas at field sites, refineries, and the like, several sampling systems have been developed based on the interaction between mercury and other substances. As opposed to analyzers that typically measure levels directly, samplers typically collect a sample that is later analyzed in a laboratory. Such sampling systems generally utilize a gold filament sample trap. A sample of the natural gas flows over the sample trap whereupon the mercury interacts with the gold.

Such sampling systems have several disadvantages. Natural gas flowing through a standard gas pipeline is maintained at a high pressure. In order to sample the gas, the gas is let down to a low pressure. The pressure drop causes the temperature of the sample flow of gas to drop dramatically and can cause condensate to form. The condensate, in turn, interferes with the measurement of constituents.

Furthermore, prior art samplers can only sample for limited duration, typically two to eight hours. It has been found, however, that over extended periods mercury concentrations can vary by up to 500%. Thus, the measurement data can vary from sample to sample on the exact same line. Prior art samplers thus have some level of inaccuracy and unreliability.

Prior art samplers also have the disadvantage of being cumbersome and difficult to move. Prior art analyzers utilize many fluidic components and connections. They also require connecting large, heavy equipment. Prior art systems are thus designed to be left in the same place for extended periods of time. It has been found, however, that the concentration of constituents, especially mercury, degrades over the length of gas pipelines. This is believed to be caused from deposition on container walls, reaction with interferents, and the like. Thus, it is desirable to sample at different locations along the length of the gas line.

Additionally, the existence of multiple contaminants can affect the accuracy, repeatability, and sensitivity of prior art samplers. For example, hydrogen sulfide can bond with mercury to form mercuric sulfide which may be less susceptible to detection in some systems. Even water molecules can affect the performance of many prior art samplers. For this reason, sampling of natural gas lines currently requires taking many samples. If the measurements fluctuate widely, then accurate measurement may be impossible.

What is needed is a method and apparatus for sampling natural gas which overcomes the above and other disadvantages of known samplers and analyzers. For example, an accurate and sensitive apparatus that can produce instantaneous results would be highly desired, as is an apparatus with improved accuracy, sensitivity, repeatability, and quality control.

Further, what is needed is an apparatus that can sample in many locations and accurately detect and measure various constituent types. For example, an apparatus that can sample for mercury of all types including metallic, organic, and ionic would be highly desired.

### BRIEF SUMMARY OF THE INVENTION

In summary, one aspect of the present invention is directed to, providing a portable mercury sample collection system.

Another aspect of the present invention is directed to an apparatus for detecting constituents in natural gas lines. The apparatus includes a source line fluidly connected to a natural gas line and configured for delivering a sample gas flow, a directional valve fluidly connected with the source line and configured for selecting a flow direction of the sample gas flow, a bypass line connected to the directional valve and configured for drawing off the sample gas, and a sample line assembly fluidly connected to the directional valve. The sample line assembly preferably includes a plurality of sample trains, and each of the sample trains preferably includes (i) a shut-off valve at an upper end thereof configured to control the sample flow therethrough, (ii) a measuring device at a lower end thereof configured for measuring flow therethrough, and (iii) a sample trap assembly intermediate the shut-off valve and the measuring device configured for collecting constituents in the sample gas flow.

In one embodiment, the source line includes a metering valve for metering sample gas flow to the directional valve and a pressure regulator for regulating pressure of the sample gas flow. The measuring device may include a dry test meter for measuring volume. The measuring device may include a flow meter for measuring flow rate. Each sample trap assembly may include a sample trap. The source line and the sample line assembly may define a flow path between the gas line and the sample trap. The flow path may be coated with an inert material.

The apparatus may further include a primary enclosure enclosing the sample trap assemblies. The primary enclosure may be configured for maintaining a selectable temperature environment around the sample trap assemblies. The primary enclosure may be aluminum. The primary enclosure may include a thermocouple, temperature controller, and heater within the primary enclosure. The primary enclosure may be removable from the sampling apparatus. The primary enclosure may be configured to maintain a temperature environment in the range of 150° to 250° F.

The apparatus may further include an auxiliary enclosure and a flow meter, wherein the auxiliary enclosure houses the flow meter. Each of the sample trap assemblies may include a series of sample traps each having a sorbent media bed. The sample line assembly may include three sample trains, each sample train including a plurality of sample traps in a series. Each series of sample traps may include a primary trap bed configured for collecting constituents to be measured from the sample gas flow, at least one secondary trap bed configured for collecting constituents that have passed through the primary bed, and a spike trap bed configured to indicate any loss or gain of mercury for quality assurance/quality control. The constituent may be mercury. The trap beds may be carbon-based. The trap beds may be noble metal-based. The gas line may be a natural gas pipeline. The gas line may be a refinery line. The apparatus may be configured to continuously direct the sample flow of gas through each of the sample trains in succession.

Another aspect of the present invention is directed to an apparatus for parametric analysis of a sample flow from a natural gas line. The apparatus preferably includes: a source line configured for fluid connection with the gas line; a sample line connected to the source line and configured for carrying the sample flow; at least three sample trains connected to the sample line; and an enclosure configured for environmentally isolating the media traps from an ambient environment. Each sample train preferably includes: a shut-off valve at an upper end of the sample train configured for turning on and shutting off the flow of sample gas through the sample train; a sample media trap downstream from the shut-off valve configured for collecting constituents from the sample gas; and a flow meter downstream from the sorbent media trap for measuring the flow rate through the trap.

The apparatus may further include a directional valve connected to the source line for selectably directing the sample flow from the gas line to one of a bypass line or the sample line. Each sample train may include a plurality of sample media traps. The constituent may be mercury. The sample media may be carbon-based.

Yet another aspect of the present invention is directed to a sampling apparatus for detecting mercury in a natural gas line. The apparatus preferably includes: a source line configured for fluid connection with a natural gas pipeline and carrying a flow of sample gas from the pipeline; a directional valve fluidly connected to the source line for directing the flow of sample downstream to a bypass line or a sample line; a carbon-based sample trap assembly fluidly connected to the sample line and configured to collect constituents from the sample to be analyzed; and a portable platform carrying the directional valve, sample line and sample trap assembly. The sample trap assembly may include a plurality of sample traps. The apparatus may further include a plurality of sample lines, each line carrying a sample trap assembly.

A further aspect of the present invention is directed to a sampling apparatus for collecting constituents in a sample flow of natural gas. The apparatus preferably includes: a source line configured for fluid connection with a gas line; a metering valve connected to the source line for adjusting a sample flow from the gas line; a directional valve configured for directing the sample flow from the source line to a bypass line or a sample line, wherein the bypass line may be configured for drawing off gas from the source line and the sample line may be configured for carrying the sample flow; and a sampling enclosure connected to the sample line and configured for thermally isolating an interior from an ambient environment. The sampling enclosure preferably includes: a heater housed within the enclosure; and a plurality of sample trains extending from the sample line through the interior of the enclosure, the sample trains being configured to carry the sample flow through a plurality of sorbent sampling beds serially arranged within each sample train, the sampling beds being configured for collecting constituents from the sample flow. The constituent may be mercury. The sampling beds may be carbon-based.

Yet a further aspect of the present invention is directed to a method of sampling a natural gas line. The method preferably includes the steps of: providing a sampling apparatus having a source line for carrying a sample flow of gas, a sample line assembly for sampling the sample flow, and bypass line for drawing off the sample flow; connecting the source line to a natural gas line; directing a sample flow of gas from the source line into a bypass line for calibration; directing the sample flow of gas from the source line into a sample line assembly for sampling; heating the sample flow of gas downstream from an inlet end of the sample line assembly; sampling the sample flow of gas by passing the sample through the sample line assembly for collecting constituents from the sample flow of gas; and measuring the sample flow of gas over the sorbent media beds.

The sampling step may be accomplished by passing the sample flow of gas over a plurality of sorbent media beds within the sample line assembly. The sampling step further may include sampling multiple sample gas flows simultaneously through a plurality of sample lines. The constituent may be mercury. The sorbent media beds may be carbon-based.

The sampling apparatus of the present invention has other features and advantages which will be apparent from or are set forth in more detail in the accompanying drawings, which are incorporated in and form a part of this specification, and the following Detailed Description of the Invention, which together serve to explain the principles of the present invention.

### BRIEF DESCRIPTION OF THE DRAWINGS

FIG. 1 is a schematic view of a sampling apparatus in accordance with the present invention, an enclosure of the apparatus shown in phantom.

FIG. 2 is an enlarged view of the sampling apparatus of FIG. 1 at a sampling point of a gas line.

FIG. 3 is a front perspective view of the enclosure of FIG. 1.

FIG. 4 is a side view of the enclosure of FIG. 1.

FIG. 5 is a front section view of the enclosure of FIG. 4.

FIG. 6 is a side section view of the enclosure of FIG. 4.

FIG. 7 is a front perspective view of an auxiliary enclosure in accordance with the present invention, the enclosure shown with a front cover in phantom.

FIG. 8 is a front section view of the auxiliary enclosure of FIG. 7.

FIG. 9 is a right-side section view of the auxiliary enclosure of FIG. 7.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

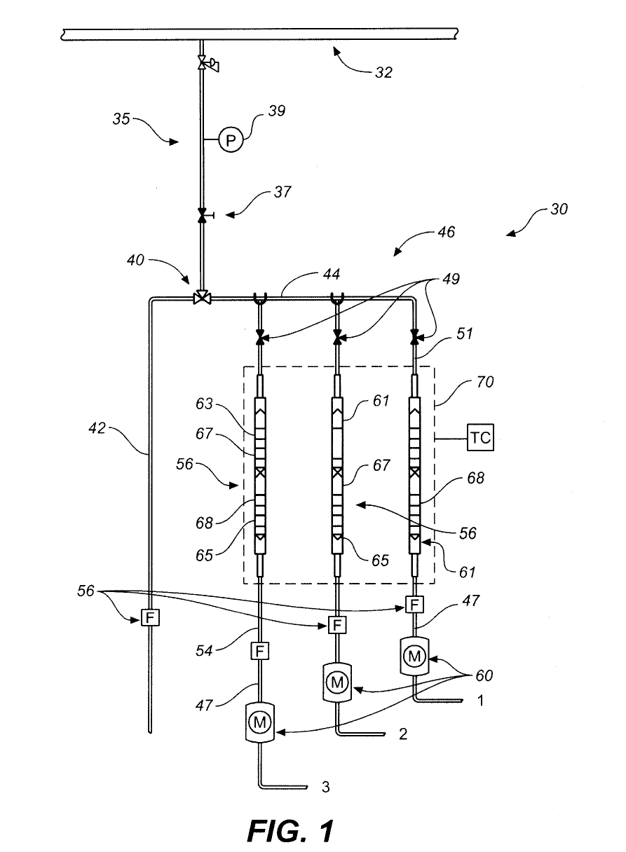

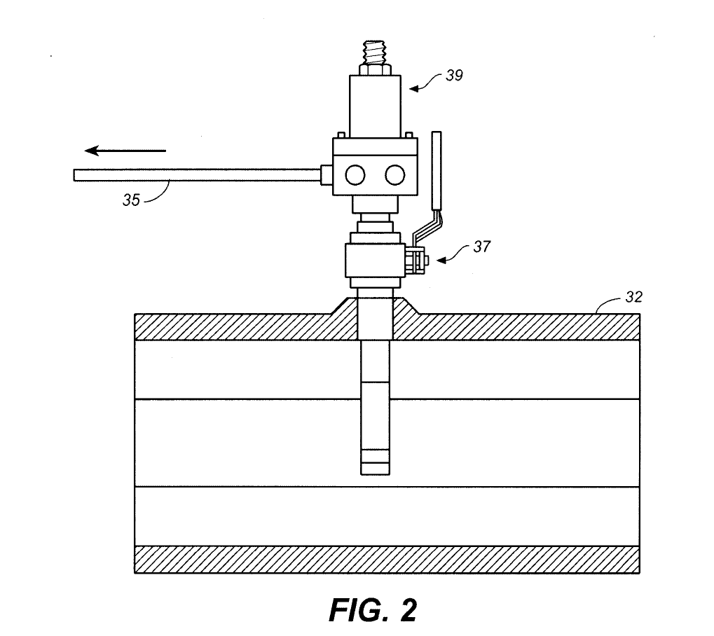

Turning now to the drawings, wherein like components are designated by like reference numerals throughout the various figures, attention is directed to a sampling apparatus, generally designated 30, shown in FIGS. 1-2. The sampling apparatus is configured for connection with a gas line 32 to sample for constituents in the gas. The illustrated embodiment is configured for use with a natural gas line, however, one will appreciate that the sampling system may be configured for other types of gas lines. Also, in the illustrated embodiment, the apparatus is connected to the pipeline at a field site location. However, the apparatus of the present invention may sample gas flow at any location including, but not limited to, lines at refinery sites, exploration sites, petrochemical plants, and other areas where sampling of natural gas may be desirable.

In the illustrated embodiment, a probe 33 extends into the gas line and directs a sample gas flow to a source line 35 of apparatus 30. A metering valve 37 and pressure regulator 39 control the flow of sample gas into apparatus 30. One will appreciate that other configurations may be employed to connect to gas line 32 depending on the sampling site and application.

Turning to FIG. 2, metering valve 37 may be a needle valve, or other suitable metering device allowing precise control of flow rate into the sampling apparatus. The metering valve meters or adjusts the flow rate through the source line of apparatus 30. The metering valve preferably allows the sample flow of gas to be precisely adjusted and completely closed. Also, preferably, the wetted surfaces of the metering valve are inert. In the illustrated embodiment, the flow rate is in the range of 0.5-1 liters/minute, but the flow rate may be below or above this range depending on the application requirements.

The pressure in a typical natural gas line is relatively high and ranges from 500-1200 pounds per square inch gas (“psig”). Therefore, pressure regulator 39 steps down and controls the pressure of the incoming flow from the gas line into the sampling apparatus. Known pressure regulators have a maximum inlet pressure of several thousand psig and a discharge pressure from 0-100 psig. In one embodiment, the pressure is stepped down to 5 psi in the sampling apparatus. In one embodiment, the pressure regulator is stainless steel with inert wetted parts, but other materials and configurations may be used depending on the application.

Turning to FIG. 1, sampling apparatus 30 includes source line 35 fluidly connected to natural gas line 32. The source line is configured to receive and deliver the sample gas flow from probe 33 into the apparatus. Suitable materials for the source line include, passivated stainless steel, TEFLON and other materials suitable for fluid handling natural gas.

A directional valve 40 fluidly connected with source line 35 allows the sample flow of gas to be directed from the source line to one of several pathways. Thus, the metering valve 37 and pressure regulator 39 adjust the flow of sample gas into the directional valve.

In the illustrated embodiment, once the gas flows through the metering valve to the directional valve, the gas flow is selectably directed to a bypass line 42 or a sample line 44. One will appreciate, however, that directional valve 40 may direct the sample gas flow to one, two, three, or more lines configured for different applications.

With continued reference to FIG. 1, bypass line 42 runs from directional valve 40 to a stack line, vent, or other system. As will be described further below, the bypass line allows the sample gas flow to be drawn off or discharged from the apparatus during calibration, removal of the sample line, and other times when the sample flow is not being analyzed. The bypass line may further allow venting of sampling apparatus 30. At a field site, the bypass line may discharge the sample flow to the environment once cleaned. In a refinery, the bypass line may be optionally connected by a waste line to a specially-configured stack for disposal, further sampling, or the like.

Sample line 44 carries the sample flow of gas from the directional valve to a sample line assembly 46. The sample line assembly includes a plurality of sample trains 47. Each of the sample trains optionally includes a block or shut-off valve 49 at an upper or upstream end 51, a measuring device 53 at a lower or downstream end 54, and a sample trap assembly 56 intermediate the shut-off valve and measuring device.

Shut-off valve 49 allows the flow of gas into the sample train to be shut off or opened as desired. The shut-off valve may also allow the rate of flow to be incrementally adjusted. Suitable shut-off valves include, but are not limited to, block valves, ball valves, gate valves, turn valves, and needle valves, all of which may be chemically-inert.

Source line 35 and sample line assembly 46 define an upstream flow path between gas line 32 and sample trap assembly 56. In one embodiment, the upstream flow path is coated with an inert material such that the sample flow of gas does not react with materials between the gas line and the sample trap assembly. The inside contact surfaces of the flow path may be coated with an inert material such as SULFINERT, PTFE, PEEK, TEFLON and similar materials that show little or no reactivity with natural gas and contaminants. In the alternative, the entire line assembly may be composed of inert materials thereby precluding interference with measuring by the sampling apparatus.

As known in the art, the level of constituent matter in the natural gas line can be determined based upon the volume or mass of constituent collected from the sample relative to the total volume of sample gas that passed through the sample trap assembly. In the illustrated embodiment, a flow meter 58 for measuring flow rate lies downstream from sample trap assembly 56. A dry test meter 60 lies downstream from the trap for measuring volume. In the illustrated embodiment, a Gilmont-shielded rotameter flow meter and standard gas meter measure the sample flow through the sample trap assembly. The primary purpose of the flow meter is to measure the flow rate through the trap assembly during adjustment of metering valve 37. One will appreciate that various other measuring devices may be employed and any number of devices and configurations may be used in conjunction with each other for measuring the rate and or volume of gas flow.

Turning now to FIGS. 1 and 3-6, at upstream end 51 of the sample train, shut-off valve 49 is configured to turn on and shut off the flow of sample gas through sample train 47. Alternatively, other common valves may be used to control the flow of sample gas through the sample train lines. In this manner, each sample train 47 can be selectively opened or closed to sample line 44 for sampling as desired.

Each sample train 47 includes a sample trap assembly 56, which in turn, includes one or more sample traps, which preferably include sorbent beds 61. In the illustrated embodiment, each sample trap assembly includes four sample traps, however, one will appreciate that the number of sorbent beds may vary. The sample trap may include a treated sorbent media affixed to a substrate that chemically traps the constituents to be measured. The sample trap may also have a physical configuration, such as a filter screen or metal nano-wool, designed to trap constituents passing therethrough.

As the sample gas flow passes through or over trap 61, the constituents adhere or become adsorbed to the sorbent media. As known in the art, sample trap 61 is removed after sampling for analysis in a laboratory. One will appreciate that the sample trap configuration may vary depending on the type of constituent to be measured, application, and the final measurement requirements. Additionally, the sample media dimensions, configuration, and composition may be varied depending on the application and sampling requirements.

In the illustrated embodiment, sample train 47 includes a plurality of sample traps 61 defining sample trap assembly 56. The sample traps are serially arranged within each sample trap assembly such that a first trap 63 in the series is the primary trap in the sample trap assembly. The first trap is configured for collecting constituents to be measured from the sample gas flow. The last trap bed in the series is a spike trap bed, or non-sampling bed, designated 65. The spiked sorbent bed is configured to contain a known amount of mercury such that laboratory analysis will indicate any loss or gain of mercury. This mechanism serves to produce data for quality assurance (“QA”) and/or quality control (“QC”) check(s). The spiked bed provides added safety and also serves as a quality control backstop. The sample trap assembly optionally includes at least one or more intermediate trap beds (e.g., second trap bed 67 and third trap bed 68) configured for collecting constituents that have passed through the preceding bed(s). The second bed may act as a quality control measure or supplement trapping by the first bed. Likewise, the third bed may also act as a quality control measure or supplement trapping by the first and second bends.

In typical runs, the first trap will collect more than three-fourths of the total collected constituent and the second bed will collect the remaining portion. If the spike bed remains virgin, meaning without any collected constituent, then one can be assured that all the constituents were removed and there was no breakthrough of the first and second beds.

In the illustrated embodiment, apparatus 30 is configured for analysis of a sample flow from a natural gas line. By using a plurality of sample trains 47, multiple sample gas flows may be analyzed simultaneously or a single flow analyzed for an extended duration. In the illustrated embodiment, apparatus 30 optionally includes three sample trains 47. The first two sample trains allow for simultaneous or sequential analysis. The third and final sample train may collect constituents for quality control purposes. When running simultaneously, all three sample trains are opened and sampling at once. When running sequentially, at least one sample train is closed at all times such. When running continuously, the sampling apparatus acts as a constituent removal or remediation apparatus.

One will appreciate that the timing and sequencing of sampling through each sample train may be varied according to the application requirements. One will further appreciate that the sampling apparatus may include two, three, four, or more sample trains in parallel or a combination of series and parallel configurations depending on the desired data, timing, and other application requirements. In the illustrated configuration, the sampling apparatus may be used for parametric analysis of the sample flow of gas while improving quality analysis and quality control (“QA/QC”). One will further appreciate that one, two, or more secondary traps may be employed in each sample trap assembly for QA/QC purposes depending on the application. In this manner, the apparatus can take multiple samples at the exact same time and sample conditions.

In one embodiment, the constituent to be measured is mercury. The present invention may also be used to detect and measure any number of constituents found in natural gas lines including, but not limited to, aromatics, radon, selenium, arsenic, antimony, tellurium, bismuth, hydrogen sulfide, SO_{X}, NO_{X}, HgS, CO₂, and so on.

When sampling for mercury, the trap beds may be carbon-based, such as an iodine or sulfur-impregnated carbon media. An example of such a trap is the FSTM trap manufactured by Frontier Geosciences, Inc. of Seattle, Wash. Alternatively, the trap beds may optionally include media composed of a noble metal such as gold, silver, or copper treated to increase sensitivity, or media composed of chemically treated filters. One will appreciate that various other media may be used depending on the application and constituent to be measured or detected.

In sampling for mercury, it has been found that gold-based sorbent traps can be poorly suited for sampling gas lines with unknown quantities of mercury. Known mercury sorbent traps typically only absorb up to 10 μg of mercury. When sampling at the average rate of 30-60 L/hr, this amount can easily be quickly exceeded in some gas lines. At higher collection levels, collection efficiency decreases and some mercury may pass through the spike bed if the sorbent traps are stressed too much. If the collection level is too high, the limit of the measuring instrument in the laboratory may also be exceeded causing the instrument to be damaged or knocked out of calibration.

Additionally, the choice of sample trap media type should be based in part upon the collection limit and analysis preparation method. For example, with known preparation techniques, multiple samples or aliquots may be obtained from a carbon-based media trap versus a gold media trap. Thus, the sampling apparatus will have to be run again if the limit of the analysis instrument is exceeded when measuring the aliquot.

In one embodiment, each of the trap beds has a different media composition. By varying the media compositions, the sampling apparatus may be configured to sample for several different constituents. As understood in the art, the varying of trap bed media composition also allows for improved QA/QC.

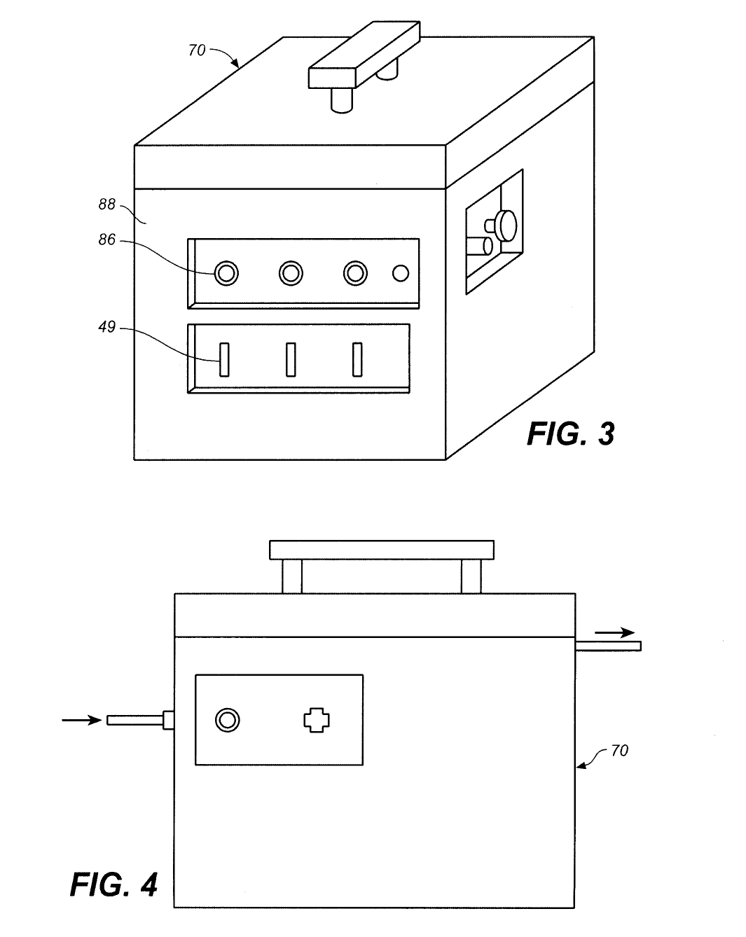

In one embodiment an optional primary enclosure 70 houses the sample trap assembly. In the illustrated embodiment shown in FIGS. 3-6, the primary enclosure is a heater box configured for maintaining a controlled temperature environment around the sample trap assemblies. Sample trains 47 optionally extend from sample line 44 through an interior of primary enclosure 70 such that sample trap assemblies 56 are thermally isolated from an ambient environment inside the primary enclosure. In one embodiment, the primary enclosure optionally includes a thermocouple 72, temperature controller 74, and heater 75. In order to comply with federal regulations and/or obtain quality measurements, the thermocouples and heater maintain a selected temperature when collecting constituent matter. In one embodiment, the interior temperature of the primary enclosure is maintained in the range of approximately 35° to 250°, preferably in the range of approximately 150 to 250° F., and most preferably approximately 200° F. Depending on the application, the temperature may be set above or below this range. The heater and enclosure may optionally be configured to maintain or reduce moisture within the enclosure in order to minimize the formation of condensate. Further, the components housed within the primary enclosure may be varied depending on the application.

In some applications, such as when sampling natural gas inside of a refinery, primary enclosure 70 may be constructed to particular specifications to comply with specific safety and operating requirements. For example, in one embodiment, the primary enclosure is composed of fireproof stainless steel to comply with refinery operating requirements.

In another embodiment, the primary enclosure is configured to hermetically isolate sample traps 61 from an ambient environment. In some applications, the sample traps collect only a few nanograms of constituent per standard cubic meter. Therefore, even the slightest outside disturbance can affect the sensitivity and accuracy of the sample trap assembly. By environmentally isolating the sample traps from air currents, outside particulates, and other disturbances, sampling can be improved. One will appreciate that the construction materials and configuration of the primary enclosure may be further varied for safety, analysis, or application reasons.

The apparatus may be configured with a portable platform to facilitate field sampling. The portable platform preferably carries directional valve 40, sample line 44, and sample train 47 including sample trap assembly 56, all of which may also be housed in an enclosure. In one embodiment, primary enclosure 70 is portable. In another embodiment, the components carried on the portable platform or primary enclosure are connected to the rest of apparatus 30 with release fittings that allow for convenient connection and disconnection. In this manner, apparatus 30 may be moved to various sampling points with greater ease as will be described below.

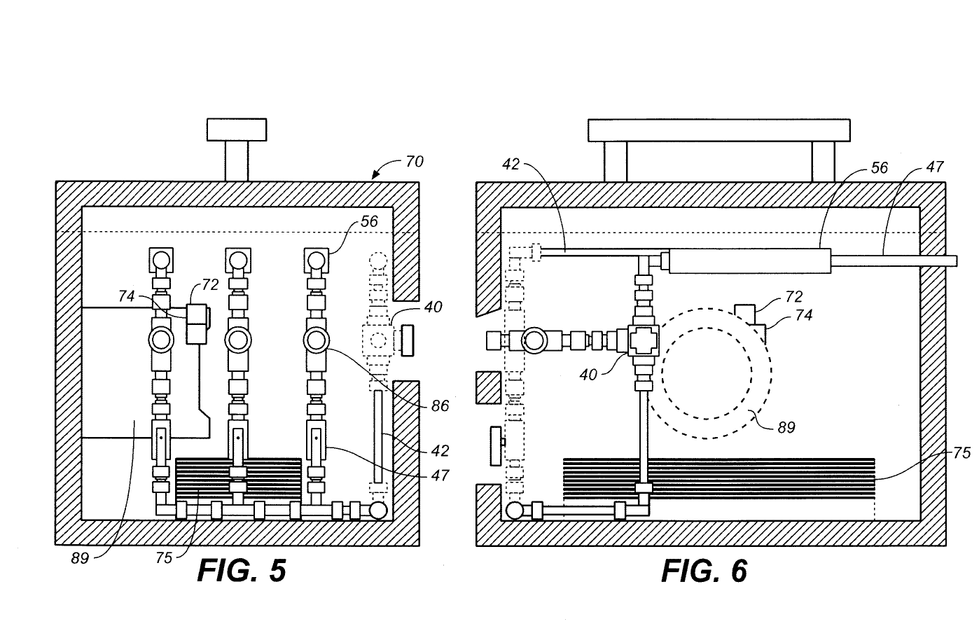

In the illustrated embodiment, the primary enclosure is optionally configured to be removable from the sampling apparatus. As shown in FIG. 5, the primary enclosure is configured to house the primary analysis components of sampling apparatus 30 including sample trains 47. The walls of the primary enclosure include inlet and outlet ports 77 such that the primary enclosure may be connected and disconnected from sample line 44 quickly and easily.

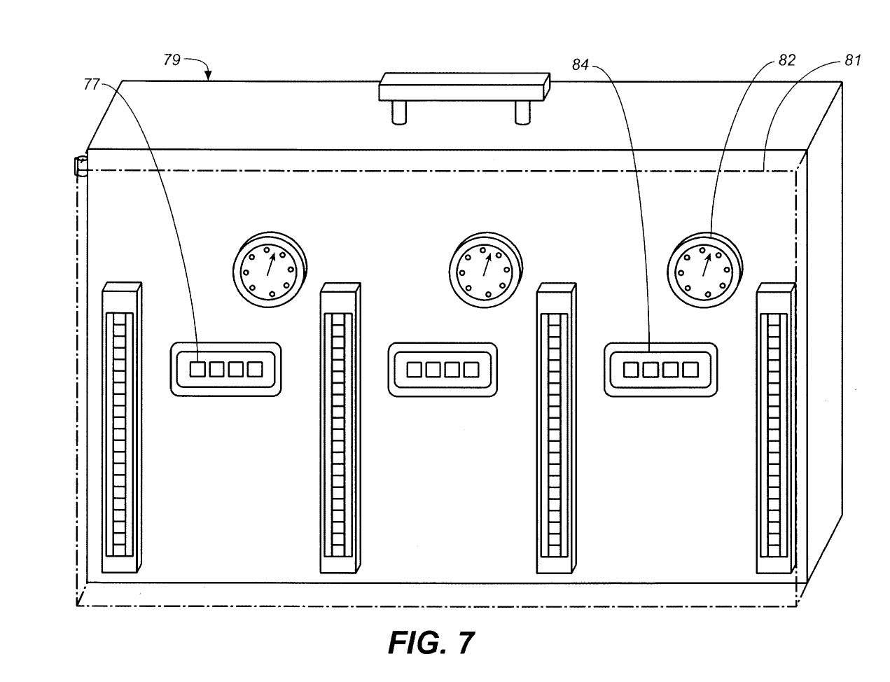

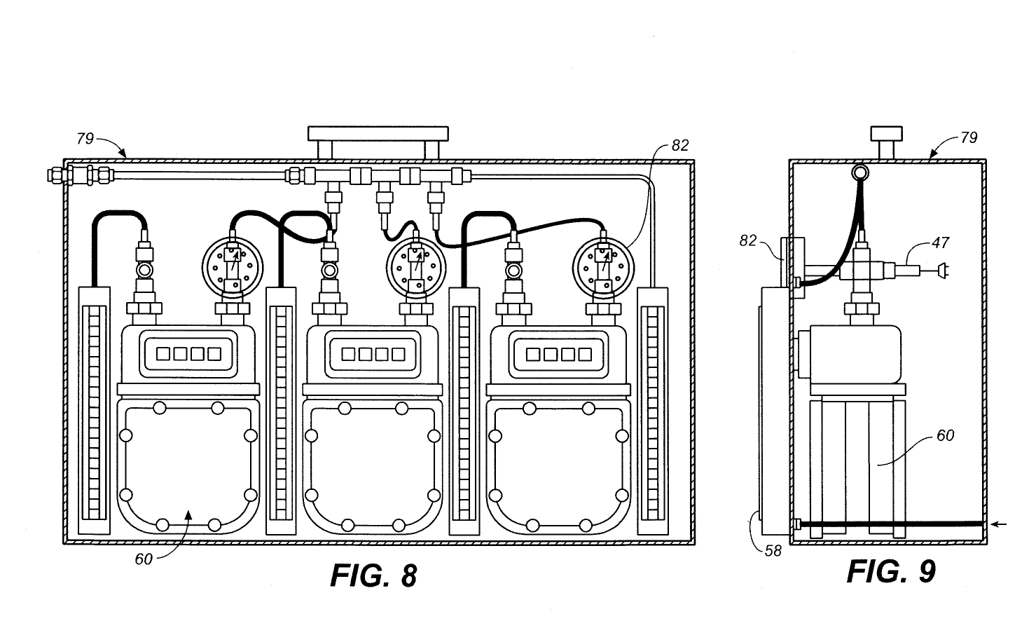

Turning to FIGS. 7-9, the apparatus may be provided with an auxiliary enclosure 79 that houses auxiliary components such as the flow meters and dry test meters. The auxiliary enclosure provides a portable platform for other components of the apparatus that do not require a heat controlled environment, however, one will appreciate that the auxiliary enclosure may be so configured, if desired. The auxiliary enclosure may optionally include a front cover 81 (shown in phantom). The front of the auxiliary enclosure includes associated gauges 82 and controls 84 for each inlet and outlet line. The auxiliary enclosure may be composed of any durable and/or corrosion-resistant material. The auxiliary enclosure may optionally include a removable back panel to allow easy access to interior fitments and connections. In one embodiment, separate auxiliary enclosures are used for each sample train line 47.

In the illustrated embodiment, the auxiliary enclosure includes three dry test meters 60 and three flow meters 58, which are configured for connection with the downstream end 54 of each of the three sample trains. One will appreciate that well-know means may be utilized to fluidly connect the meters to their respective sample trains. Flow meters 58 are mounted on a front face of the enclosure and enclosed behind front cover 88. Measuring devices 53 and auxiliary enclosure 79 lie downstream or at a lower end of sample trains 47.

A method of sampling natural gas in accordance with the present invention can now be described. Turning to FIGS. 1-2, apparatus 30 feeds from the natural gas line being sampled. Source line 35 connects to the gas line such that the sample flow of gas is siphoned from the gas line.

Turning to FIGS. 1 and 5-6, downstream from the source line, the sample flow of gas is directed to either bypass line 42, sample line 44, or both. Initially, the sample flow of gas is directed to the bypass line for calibration purposes. As will be understood in the art, the bypass line vents the flow of gas from the source line. The pressure, flow rate, and other characteristics can be adjusted while the sample flows through the bypass line without affecting the sample trap assembly.

Turning to FIG. 3-6, the sample flow of gas is next directed to sample line assembly 46 for sampling. In the illustrated embodiment, the sample line assembly includes sample line 44 and three sample trains 47 connected along a length of the sample line. Alternatively, the plurality of sample trains may optionally be in direct fluid communication with source line 35 via a multi-way directional valve. Other suitable fluidic configurations include, but are not limited to, use of a plurality of elbows and multiple directional valves. In the illustrated embodiment, the fluidic tubes within the primary enclosure are ¼″ stainless steel tubes deactivated with an inert chemical or coating.

In the illustrated embodiment, primary enclosure 70 houses the trap assembly components, which are downstream from the sample line and upstream from the flow meters. The primary enclosure includes three sample lines 44 with similar flow paths to allow the sampling of multiple sample flows simultaneously or in sequence. In order to sample through all three sample lines simultaneously, a user opens sample line metering valves 86 and block valves 49 to open each sample line assembly. In order to sample sequentially over an extended period of time, each sample line is opened sequentially and only one sample line is opened at a time. For example, in a typical sample run for mercury in a natural gas line, the sample trap assembly 56 must be exchanged after a certain period of time, for example, in seven days. In this case, by running four sample line assemblies in sequential order, the sample run time may be extended to 21 days when three trap assemblies are used in sequence. As understood in the art, the transition from one sample line assembly to the next may be effectuated manually or automatically. Alternatively, groups of sample lines may be opened sequentially in order to extend the overall sampling time and maintain the benefit of an additional sample line for quality control purposes. For example, the apparatus may include six sample line assemblies with three opened during a first phase and the final three opened for the second phase, and so on.

After the sample flow is fed through the source line, the sample flow of gas is directed through optional sample line metering valves 86 on a front panel 88 of the primary enclosure (shown in FIG. 3). The front panel further optionally includes several block valves 49 corresponding to each sample train thus providing a convenient means to open or close each sample train assembly. The metering valves and block valves determine how much sample flow of gas passes through the primary enclosure and through which sample trains.

Turning to FIGS. 5-6, the sample flow is directed through sample line metering valves 86 located at an inlet end of sample line assemblies 46, which are housed in the primary enclosure. The sample flow is then directed downward by a three-way diaphragm valve 40. Thermocouple 72 measures the interior temperature of the heater box and sends temperature data to a junction box 89 including temperature controller 74, and thus can maintain a substantially constant temperature within the enclosure. The junction box may optionally include a control knob protruding through a wall of the primary enclosure to allow a user to select a temperature without opening the primary enclosure or stopping the sample run.

The sample flow is directed to the front panel of the primary enclosure and driven up to the sample trap assemblies at a top portion of the primary enclosure. Suitable materials for the tubing in the primary enclosure include, but are not limited to, passivated stainless steel, TEFLON and other suitable materials.

The sample flow is directed through sample trap assemblies 56. The sample flow is passed over a plurality of sorbent media beds within the sample trap assemblies. As described above, the media beds or traps collect the constituents from the sample flow for analysis after sampling.

After passing through the sample trap assemblies, the sample flow moves to measuring device 53. In the illustrated embodiment, the flow meter and test meter are housed separately from the sampling components in auxiliary enclosure 79 (shown in FIG. 7). Whereas the primary enclosure optionally houses the sample trap assemblies and associated components, the auxiliary enclosure optionally houses components downstream from the sample trap assemblies. As described above, the flow meters measure the sample flow of gas that passed through the sorbent media beds in each sample trap assembly. The auxiliary enclosure includes inlet ports 77 for the sample flow. The sample flow is fed through the inlets and passes through flow meters 58 in a front portion of the auxiliary enclosure. Next, the sample flow is directed through dry test meters 60 and out the rear of the auxiliary enclosure.

In operation and use, the optional primary and auxiliary enclosures allow a user to move the sampling apparatus easily and quickly. As described above, the primary components of the apparatus are housed in the primary and auxiliary enclosures. In one embodiment, both the primary enclosure and auxiliary enclosure are portable, hand-held encasements. In one embodiment, the primary enclosure and auxiliary enclosure further include fitments and ports on the outside panels to allow for easy connect/disconnect.

Once a user connects the apparatus to the gas line for sampling, the source line can be connected directly to the primary enclosure. Next, a fluidic tube can be connected between the primary enclosure and auxiliary enclosure. Finally, the auxiliary enclosure can be connected to applicable waste lines for disposal or redirecting of the sample flow.

Once the tubing is connected, the apparatus can be adjusted and prepared for sampling. The pressure regulator is set to a specified pressure, such as 10 psig or other suitable pressure. The flow rate through metering valve 37 is then set to, for example, 0.5 liters/minute, or other suitable flow rate. Next, the block valves and sample line metering valves 86 can be opened to let sample flow pass into the sample line assembly. The flow rate can then be measured downstream through the flow meter while the sample flow is adjusted. Thereafter, the block valves are closed and the sample trap assembly put in place.

In another embodiment of the present invention, the primary enclosure and the auxiliary enclosure remain in fluid connection and housed on a single portable platform. In this manner, the entire apparatus can be moved easily and a user need only connect the source line. One will appreciate that other enclosure configurations may be utilized including, but not limited to, a single enclosure housing the sample trap assemblies and the measuring devices.

In the illustrated embodiment, the metering valve, pressure regulator, directional valve, and measuring devices are all manually actuated, but one will appreciate that the apparatus and other aspects of the present invention may also be automatically actuated with or without computer control.

In some applications, it may be necessary to spike apparatus 30 prior to sampling as known in the art. In this case, a known mass of mercury in gaseous or liquid salt solution is delivered to the sample trap assembly. Sampling apparatus 30 may also be purged or cleaned at various stages in the sampling process in order to improve measurements. For example, it might be desirable to purge the bypass line and sample line assembly with an inert chemical treatment prior to installing the sample traps. It might also be desirable to purge the apparatus after sampling the gas line and removing the sample traps in preparation for reuse.

The sampling apparatus as shown and described has several advantages over the prior art. One skilled in the art will appreciate that the apparatus provides better accuracy and repeatability than existing sampling devices. Additionally, one will appreciate that the ability to conduct parametric analyses and/or extended sampling times provides improved QA/QC.

In one embodiment, the apparatus of the present invention has the advantage of ease of assembly and installation to the gas line to be sampled. The portability of the illustrated embodiment further allows the apparatus to be easily moved to multiple locations for sampling. For example, the gas line may be sampled at several points along the same section of the line in order to determine if the constituent level varies along the length. This also allows the ability to determine the source or location of introduction of a known constituent.

Additionally, the apparatus in accordance with the present invention allows a user to control the conditions under which the sample flow of gas is sampled. The apparatus also advantageously isolates the sample traps from outside disturbances and condensate.

For convenience in explanation and accurate definition in the appended claims and detailed description, the terms “upper” and “lower” are used to describe features of the present invention with reference to the positions of such features as displayed in the figures.

In many respects the modifications of the various figures resemble those of preceding modifications and the same reference numerals followed by subscripts “a”, “b”, “c”, and “d” designate corresponding parts.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An apparatus for detecting constituents in natural gas lines, said apparatus comprising:
a source line fluidly connected to a natural gas line and configured for delivering a sample gas flow;
a directional valve fluidly connected with the source line and configured for selecting a flow direction of the sample gas flow;
a bypass line connected to the directional valve and configured for drawing off the sample gas; and
a sample line assembly fluidly connected to the directional valve, the sample line assembly including a plurality of sample trains, each of the sample trains including (i) a shut-off valve at an upper end thereof configured to control the sample flow therethrough, (ii) a measuring device at a lower end thereof configured for measuring flow therethrough, and (iii) a sample trap assembly intermediate the shut-off valve and the measuring device configured for collecting constituents in the sample gas flow.

2. An apparatus according to claim 1, wherein the source line includes a metering valve for metering sample gas flow to the directional valve and a pressure regulator for regulating pressure of the sample gas flow.

3. An apparatus according to claim 2, wherein the measuring device includes a dry test meter for measuring volume.

4. An apparatus according to claim 2, wherein the measuring device includes a flow meter for measuring flow rate.

5. An apparatus according to claim 1, wherein each sample trap assembly includes a sample trap.

6. An apparatus according to claim 5, wherein the source line and the sample line assembly define a flow path between the gas line and the sample trap, and wherein the flow path is coated with an inert material.

7. An apparatus according to claim 5, further comprising a primary enclosure enclosing the sample trap assemblies.

8. An apparatus according to claim 7, wherein the primary enclosure is configured for maintaining a selectable temperature environment around the sample trap assemblies.

9. An apparatus according to claim 8, wherein the primary enclosure is aluminum.

10. An apparatus according to claim 8, wherein the primary enclosure includes a thermocouple, temperature controller, and heater within the primary enclosure.

11. An apparatus according to claim 10, wherein the primary enclosure is removable from the sampling apparatus.

12. An apparatus according to claim 10, wherein the primary enclosure is configured to maintain a temperature environment in the range of 150° to 250° F.

13. An apparatus according to claim 7, further comprising an auxiliary enclosure and a flow meter, wherein the auxiliary enclosure houses the flow meter.

14. An apparatus according to claim 1, wherein each of the sample trap assemblies includes a series of sample traps each having a sorbent media bed.

15. An apparatus according to claim 14, wherein the sample line assembly includes three sample trains, each sample train including a plurality of sample traps in a series.

16. An apparatus according to claim 14, wherein each series of sample traps includes a primary trap bed configured for collecting constituents to be measured from the sample gas flow, at least one secondary trap bed configured for collecting constituents that have passed through the primary bed, and a spike trap bed configured to indicate any loss or gain of mercury for quality assurance/quality control.

17. An apparatus according to claim 16, wherein the constituent is mercury.

18. An apparatus according to claim 17, wherein the trap beds are carbon-based.

19. An apparatus according to claim 17, wherein the trap beds are noble metal-based.

20. An apparatus according to claim 1, wherein the gas line is a natural gas pipeline.

21. An apparatus according to claim 1, wherein the gas line is a refinery line.

22. An apparatus according to claim 15, wherein the apparatus is configured to continuously direct the sample flow of gas through each of the sample trains in succession.

23. An apparatus for parametric analysis of a sample flow from a natural gas line, the apparatus comprising:
a source line configured for fluid connection with the gas line;
a sample line connected to the source line and configured for carrying the sample flow;
at least three sample trains connected to the sample line, each sample train including:
a shut-off valve at an upper end of the sample train configured for turning on and shutting off the flow of sample gas through the sample train;
a sample media trap downstream from the shut-off valve configured for collecting constituents from the sample gas; and
a flow meter downstream from the sorbent media trap for measuring the flow rate through the trap; and
an enclosure configured for environmentally isolating the media traps from an ambient environment.

24. An apparatus according to claim 22, further comprising a directional valve connected to the source line for selectably directing the sample flow from the gas line to one of a bypass line or the sample line.

25. An apparatus according to claim 22, wherein each sample train includes a plurality of sample media traps.

26. An apparatus according to claim 22, wherein the constituent is mercury.

27. An apparatus according to claim 26, wherein the sample media is carbon-based.

28. A sampling apparatus for detecting mercury in a natural gas line, the apparatus comprising:
a source line configured for fluid connection with a natural gas pipeline and carrying a flow of sample gas from the pipeline;
a directional valve fluidly connected to the source line for directing the flow of sample downstream to a bypass line or a sample line;
a carbon-based sample trap assembly fluidly connected to the sample line and configured to collect constituents from the sample to be analyzed; and
a portable platform carrying the directional valve, sample line and sample trap assembly.

29. A sampling apparatus according to claim 28, wherein the sample trap assembly includes a plurality of sample traps.

30. A sampling apparatus according to claim 29, further including a plurality of sample lines, each line carrying a sample trap assembly.

31. A portable sampling apparatus for collecting constituents in a sample flow of natural gas, the apparatus including:
a source line configured for fluid connection with a gas line;
a metering valve connected to the source line for adjusting a sample flow from the gas line;
a directional valve configured for directing the sample flow from the source line to a bypass line or a sample line, wherein the bypass line is configured for drawing off gas from the source line and the sample line is configured for carrying the sample flow; and
a sampling enclosure connected to the sample line and configured for thermally isolating an interior from an ambient environment, the sampling enclosure including:
a heater housed within the enclosure;
a plurality of sample trains extending from the sample line through the interior of the enclosure, the sample trains being configured to carry the sample flow through a plurality of sorbent sampling beds serially arranged within each sample train, the sampling beds being configured for collecting constituents from the sample flow.

32. A sampling apparatus according to claim 31, wherein the constituent is mercury.

33. A sampling apparatus according to claim 32, wherein the sampling beds are carbon-based.

34. A method of sampling a natural gas line, the method comprising the steps of:
providing a sampling apparatus having a source line for carrying a sample flow of gas, a sample line assembly for sampling the sample flow, and bypass line for drawing off the sample flow;
connecting the source line to a natural gas line;
directing a sample flow of gas from the source line into a bypass line for calibration;
directing the sample flow of gas from the source line into a sample line assembly for sampling;
heating the sample flow of gas downstream from an inlet end of the sample line assembly;
sampling the sample flow of gas by passing the sample through the sample line assembly for collecting constituents from the sample flow of gas; and
measuring the sample flow of gas over the sorbent media beds.

35. The method of claim 34, wherein the sampling step is accomplished by passing the sample flow of gas over a plurality of sorbent media beds within the sample line assembly.

36. The method according to claim 35, wherein the sampling step further includes sampling multiple sample gas flows simultaneously through a plurality of sample lines.

37. The method according to claim 34, wherein the constituent is mercury.

38. The method according to claim 37, wherein the sorbent media beds are carbon-based.
